(19) United States
(12) Patent Application Publication
(10) Pub. No.: US 2013/0054403 A1
(43) Pub. Date: Feb. 28, 2013

(54) SYSTEMS, PROGRAM PRODUCTS, AND RELATED METHODS OF PROVIDING PRODUCTS AND SERVICES TO BUYER POPULATIONS

(71) Applicant: Christopher C. Sappenfield, San Diego, CA (US)

(72) Inventor: Christopher C. Sappenfield, San Diego, CA (US)

(73) Assignee: Christopher C. Sappenfield, San Diego, CA (US)

(21) Appl. No.: 13/594,862

(22) Filed: Aug. 26, 2012

Related U.S. Application Data
(60) Provisional application No. 61/528,213, filed on Aug. 27, 2011.
(60) Provisional application No. 61/652,517, filed on May 29, 2012.

(51) Int. Cl. G06Q 30/08

(52) U.S. Cl. 705/26.3

(57) ABSTRACT

The invention provides methods of identifying buyer populations that include receiving bids for products and/or services to generate bidder populations and segmenting those bidder populations into buyer and remainder populations in certain embodiments. The invention also provides methods of providing products and/or services to buyer populations that include receiving bids for the products and/or services to generate bidder populations, selecting buyer populations in the bidder populations, making the products and/or services available to the buyer populations, and receiving payments from the buyer populations in some embodiments. In addition to other methods, related machine-readable media and systems are also provided.

### CROSS-REFERENCE TO RELATED APPLICATIONS

This application claims the benefit of priority from U.S. Provisional Patent Application Nos. 61/528,213, filed Aug. 27, 2011 and 61/652,517, filed May 29, 2012, which are both incorporated by reference in their entirety.

### FIELD OF THE INVENTION

The present invention relates generally to the field of commerce. In certain embodiments, for example, methods of identifying buyer populations and providing products and services to those populations are provided.

### BACKGROUND OF THE INVENTION

The concept of bargaining power relates to the relative abilities of parties in a given situation to exert influence over each other. In many commercial transactions, for example, a seller of a particular product or service has greater bargaining power than individual buyers due to the seller's size, market share, intellectual property rights, or absence of competing products or services, among other factors. As a consequence, individual buyers are often unable to significantly influence the seller's offering price for the product or service in these transactions and accordingly, the price tends to favor the seller. Therefore, from the buyer's perspective, mechanisms that provide more bargaining power to buyers in these types of conventional transactions are desirable.

### SUMMARY OF THE INVENTION

The present invention provides systems, computer program products, and related methods of providing products and services to buyers, supplying products and services to bidder populations, financing transactions to buy products and services, and managing funds, among many other aspects. In some embodiments, for example, the invention provides methods of identifying buyer populations for products and services. A buyer population generally includes multiple buyers that are each willing to pay at or above a given target price for the products and services. In transactions for the products or services, buyer populations (e.g., via a buyer population representative) are typically able to exert greater bargaining power than individual buyers vis-à-vis the products or services suppliers.

In one aspect, the invention provides a method of identifying at least one buyer population. The method includes receiving bids for at least one product and/or service from a number of bidders to generate at least one bidder population, wherein a bid comprises a bid price that at least one bidder will pay to receive at least one unit of the product and/or service. In certain embodiments of the methods, systems, and other aspects of the invention, the bids received from bidders are non-binding. The method also includes segmenting the bidder population into at least one buyer population and at least one remainder population when a number of bids comprising bid prices at or above at least one target price equals or exceeds at least one threshold number, wherein the buyer population comprises bids comprising bid prices at or above the target price, wherein the remainder population comprises bids comprising bid prices below the target price, and wherein the number of bids, the target price and/or the threshold number is unknown to the bidder population, thereby identifying the buyer population.

The methods of the invention include various embodiments. In some embodiments, for example, the bidder population and/or the buyer population comprises at least about 10 bidders, at least about 25 bidders, at least about 50 bidders, at least about 100 bidders, at least about 500 bidders, at least about 1000 bidders, at least about 5000 bidders, at least about 10000 bidders, or more bidders. In certain embodiments, a size of the buyer population is at least about 5%, at least about 10%, at least about 20%, at least about 30%, at least about 40%, at least about 50%, at least about 60%, at least about 70%, at least about 80%, or at least about 90% of a size of the bidder population. In some embodiments, the threshold number comprises at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, at least about 900, at least about 1000, at least about 2000, at least about 3000, at least about 4000, at least about 5000, at least about 6000, at least about 7000, at least about 8000, at least about 9000, or at least about 10000.

Typically, the methods of the invention include receiving at least one request for the product and/or service from at least one prospective bidder. In some of these embodiments, the methods include receiving the bids for the product and/or service after a number of requests for the product and/or service equals or exceeds at least one selected number. In some embodiments, at least one of the steps of the methods of the invention is at least partially computer implemented. In certain embodiments of the methods of the invention, the bid comprises at least one selected option profile for the product and/or service. In some embodiments of the methods of the invention, the bid price of at least a first bidder is unknown to at least a second bidder. In certain embodiments, the methods include establishing at least one cost of at least one quantity of the product and/or service with at least one supplier prior to, concurrent with, or after segmenting the bidder population. In certain embodiments, the methods include establishing different costs of different quantities of the product and/or service with at least one supplier prior to, concurrent with, or after segmenting the bidder population. In some embodiments, the invention includes a machine-readable medium storing instructions which, when executed by a machine, cause the machine to perform at least a portion of one or more of the methods described herein. In certain embodiments of the methods of the invention, the buyer population is selected when B#BP≧TPₙ≧T#ₙ, where B#→BP≧TP is a number of bidders submitting bid prices at or above at least one target price, BP is a bid price, TP is a target price, n is the level number and is an integer greater than zero, B#→BP≧TPₙ is B#→BP≧TP at a given level number n, T# is a threshold number, and T#ₙ is T# at a given level number n. In some embodiments, the methods include receiving one or more deposits from one or more of the bidders in the bidder population. In some of these embodiments, the methods include receiving the deposit from one or more of the bidders prior to, concurrent with, or after segmenting the bidder population.

In some embodiments, the methods of the invention include providing information to prospective bidders that comprises at least one attribute of the product and/or service. In some of these embodiments, for example, the methods include providing electronic digital information to the buyers that causes the attribute of the product and/or service to be displayed.

In certain embodiments, the methods of the invention include querying at least one database that comprises the threshold number. The database typically includes a plurality of threshold numbers indexed to a plurality of different products and/or services. In some embodiments, the database comprises threshold numbers indexed to selected option profiles for the product and/or service.

In certain embodiments, the methods of the invention include providing feedback to one or more bidders in response to the bids received from the bidders. In some of these embodiments, for example, the feedback comprises a probability of the bidders being included in the buyer population.

In some embodiments, the methods of the invention include obtaining at least one quantity of the product and/or service from at least one supplier at a cost at or below the target price. Typically, the target price is unknown to the supplier. In some embodiments, cost and/or the quantity of the product and/or service is established with the supplier prior to, concurrent with, or after segmenting the bidder population. In certain embodiments, different costs of different quantities of the product and/or service are established with the supplier prior to, concurrent with, or after segmenting the bidder population.

In some embodiments, the methods of the invention include obtaining at least one quantity of the product and/or service from at least one supplier at a cost at or below the target price. In these embodiments, the target price is typically unknown to the supplier. In these embodiments, the quantity of the product and/or service generally equals or exceeds the threshold number.

In certain embodiments, the methods of the invention include making the product and/or service available to the buyer population. In some of these embodiments, the methods include receiving buyer payments from paying buyers in the buyer population, wherein a buyer payment comprises an amount equal to or greater than the bid price of the bid received from a given bidder in the buyer population. In certain of these embodiments, the methods include receiving one or more deposits from one or more of the bidders in the bidder population. In some of these embodiments, for example, the methods include receiving the deposit from one or more of the bidders prior to segmenting the bidder population, when segmenting the bidder population, or after segmenting the bidder population. In some of these embodiments, the methods include receiving buyer payments from paying buyers in the buyer population, wherein at least one buyer payment comprises an amount equal to or greater than the bid price of the bid received from the given bidder in the buyer population less the deposit received from the given bidder in the buyer population. In certain embodiments, the methods of the invention include retaining at least a portion of the deposit (e.g., as a liquidated damages amount, a transaction fee, consideration for an option contract, etc.) received from at least one non-paying buyer in the buyer population when the non-paying buyer fails to pay the buyer payment. Typically, these methods also include retaining the product and/or service from the non-paying buyer.

In some embodiments, the methods of the invention include making the product and/or service available to the remainder population. In some of these embodiments, for example, the methods include receiving remainder payments, if any, from paying remainders in the remainder population, wherein a remainder payment comprises an amount equal to or greater than the target price. In certain of these embodiments, the methods include receiving one or more deposits from one or more of the bidders in the remainder population. In some of these embodiments, the methods include receiving the deposit from one or more of the bidders prior to segmenting the bidder population, when segmenting the bidder population, or after segmenting the bidder population. In certain embodiments, the methods of the invention include receiving remainder payments, if any, from paying remainders in the remainder population, wherein at least one remainder payment comprises an amount equal to or greater than the target price less the deposit received from a given bidder in the remainder population. In some embodiments, these methods include returning the deposit received from at least one non-paying remainder in the remainder population when the non-paying remainder fails to pay the remainder payment. These methods also typically include retaining the product and/or service from the non-paying remainder.

In another aspect, the invention provides a method of providing a product and/or service to a buyer population. The method includes receiving bids for the product and/or service from a number of bidders to generate at least one bidder population, wherein a bid comprises a bid price that at least one bidder will pay to receive the product and/or service. The method also includes selecting at least one buyer population from the bidder population when a number of bids comprising bid prices at or above at least one target price equals or exceeds at least one threshold number, wherein the buyer population comprises bids comprising bid prices at or above the target price. In addition, the method also includes making the product and/or service available to the buyer population, and receiving payments from at least a portion of the buyer population, wherein a payment comprises an amount equal to or greater than the bid price of the bid received from a given bidder in the buyer population, thereby providing the product and/or service to the buyer population. Typically, the bid comprises the bid price that the bidder will pay to receive at least one unit of the product and/or service. In some embodiments, the buyer population comprises only bids comprising bid prices at or above the target price. In certain embodiments, the number of bids, the target price and/or the threshold number is unknown at least to the buyer population. In some embodiments, the methods include establishing at least one cost of at least one quantity of the product and/or service with at least one supplier prior to, concurrent with, or after selecting the buyer population. In certain embodiments, the methods include establishing different costs of different quantities of the product and/or service with at least one supplier prior to, concurrent with, or after selecting the buyer population. In certain embodiments, the method includes receiving at least one deposit from one or more of the bidders in the bidder population and/or the buyer population. In some of these embodiments, for example, the method includes receiving the deposit from one or more of the bidders prior to selecting the buyer population, when selecting the buyer population, or after selecting the buyer population. In some embodiments, the methods of the invention include obtaining at least one quantity of the product and/or service from at least one supplier at a cost at or below the target price. In some of these embodiments, the cost and/or the quantity of the product and/or service is established (e.g., agreed to, etc.) with the supplier prior to, concurrent with, or after selecting the buyer population. In some of these embodiments, different costs of different quantities of the product and/or service are established with the supplier prior to, concurrent with, or after selecting the buyer population.

In another aspect, the invention provides a method of providing a product and/or service to a bidder population. The method includes receiving bids for the product and/or service from a number of bidders to generate at least one bidder population, wherein a bid comprises a bid price that at least one bidder will pay to receive at least one unit of the product and/or service. The method also includes receiving one or more deposits from one or more of the bidders in the bidder population. The method further includes segmenting the bidder population into at least one buyer population and at least one remainder population when a number of bids comprising bid prices at or above at least one target price equals or exceeds at least one threshold number, wherein the buyer population comprises bids comprising bid prices at or above the target price, wherein the remainder population comprises bids comprising bid prices below the target price, and wherein the number of bids, the target price and/or the threshold number is unknown to the bidder population. The method also includes making the product and/or service available to the buyer population and to the remainder population, and receiving buyer payments from paying buyers in the buyer population, wherein a buyer payment comprises an amount equal to or greater than the bid price of the bid received from a given bidder in the buyer population less the deposit received from the given bidder in the buyer population. The method also includes retaining the deposit received from at least one non-paying buyer in the buyer population when the non-paying buyer fails to pay the buyer payment, and retaining the product and/or service from the non-paying buyer. The method also includes receiving remainder payments, if any, from paying remainders in the remainder population, wherein a remainder payment comprises an amount equal to or greater than the target price less the deposit received from a given bidder in the remainder population. The method also includes returning the deposit received from at least one non-paying remainder in the remainder population when the non-paying remainder fails to pay the remainder payment. In addition, the method also includes retaining the product and/or service from the non-paying remainder, thereby providing the product and/or service to the bidder population.

In another aspect, the invention provides a method of providing a product and/or service to a bidder population. The method includes receiving bids for the product and/or service from a number of bidders to generate at least one bidder population, wherein a bid comprises a bid price that at least one bidder will pay to receive at least one unit of the product and/or service. The method also includes segmenting the bidder population into at least one buyer population and at least one remainder population when a number of bids comprising bid prices at or above at least one target price equals or exceeds at least one threshold number, wherein the buyer population comprises bids comprising bid prices at or above the target price, wherein the remainder population comprises bids comprising bid prices below the target price, and wherein the number of bids, the target price and/or the threshold number is unknown to the bidder population. The method also includes making the product and/or service available to the buyer population and to the remainder population. The method also includes receiving buyer payments from paying buyers in the buyer population, wherein a buyer payment comprises an amount equal to or greater than the bid price of the bid received from a given bidder in the buyer population. In addition, the method also includes receiving remainder payments, if any, from paying remainders in the remainder population, wherein a remainder payment comprises an amount equal to or greater than the target price, thereby providing the product and/or service to the bidder population.

Typically, at least one of the buyer payments comprises an amount equal to or greater than the bid price of the bid received from the given bidder in the buyer population less the deposit received from the given bidder in the buyer population. In some embodiments, the method includes retaining the deposit received from at least one non-paying buyer in the buyer population when the non-paying buyer fails to pay the buyer payment. In these embodiments, the method also typically includes retaining the product and/or service from the non-paying buyer. In some embodiments, at least one of the remainder payments comprises an amount equal to or greater than the target price less the deposit received from a given bidder in the remainder population. In certain embodiments, the method includes returning the deposit received from at least one non-paying remainder in the remainder population when the non-paying remainder fails to pay the remainder payment. In these embodiments, the method typically includes retaining the product and/or service from the non-paying remainder.

In another aspect, the invention provides a method of providing a product and/or service to a bidder population. The method includes receiving bids for the product and/or service from a number of bidders to generate at least one bidder population, wherein a bid comprises a bid price that at least one bidder will pay to receive at least one unit of the product and/or service. The method also includes receiving one or more deposits from one or more of the bidders in the bidder population. The method also includes obtaining at least one quantity of the product and/or service from at least one supplier at a cost at or below at least one target price when a number of bids comprising bid prices at or above the target price equals or exceeds at least one threshold number, wherein the bid price of a given bidder, the number of bids, the target price, and/or the threshold number is unknown to the bidder population and/or to the supplier. The method also includes making the product and/or service available to the bidder population. The method also includes receiving high bidder payments from high bidders in the bidder population, wherein a high bidder payment comprises an amount equal to or greater than the bid price of the bid received from a given high bidder in the bidder population less the deposit received from the given high bidder in the bidder population and wherein the bid price of the bid received from the given high bidder equals or exceeds the target price. The method also includes retaining the deposit received from at least one non-paying high bidder in the bidder population when the non-paying high bidder fails to pay the high bidder payment, and retaining the product and/or service from the non-paying high bidder. The method also includes receiving low bidder payments, if any, from paying low bidders in the bidder population, wherein a low bidder payment comprises an amount equal to or greater than the target price less the deposit received from a given low bidder in the low bidder population. The method also includes returning the deposit received from at least one non-paying low bidder in the bidder population when the non-paying low bidder fails to pay the low bidder payment. In addition, the method also includes retaining the product and/or service from the non-paying low bidder, thereby providing the product and/or service to the bidder population.

In another aspect, the invention provides a method of providing a product and/or service to a bidder population. The method includes receiving bids for the product and/or service from a number of bidders to generate at least one bidder population, wherein a bid comprises a bid price that at least one bidder will pay to receive at least one unit of the product and/or service. The method also includes making the product and/or service available to the bidder population when a number of bids comprising bid prices at or above at least one target price equals or exceeds at least one threshold number, wherein the bid price of a given bidder, the number of bids, the target price, and/or the threshold number is unknown to the bidder population. The method also includes receiving high bidder payments from high bidders in the bidder population, wherein a high bidder payment comprises an amount equal to or greater than the bid price of the bid received from a given high bidder in the bidder population and wherein the bid price of the bid received from the given high bidder equals or exceeds the target price, in addition, the method also includes receiving low bidder payments, if any, from paying low bidders in the bidder population, wherein a low bidder payment comprises an amount equal to or greater than the target price.

Typically, the method also includes obtaining at least one quantity of the product and/or service from at least one supplier at a cost at or below at least one target price when a number of bids comprising bid prices at or above the target price equals or exceeds at least one threshold number. In some embodiments, the method includes receiving one or more deposits from one or more of the bidders in the bidder population. In certain embodiments, the method includes receiving the deposit from one or more of the bidders prior to making the product and/or service available to the bidder population. In some of these embodiments, at least one of the high bidder payments comprises an amount equal to or greater than the bid price of the bid received from the given high bidder in the bidder population less the deposit received from the given high bidder in the bidder population. In some of these embodiments, the method includes retaining the deposit received from at least one non-paying high bidder in the bidder population when the non-paying high bidder fails to pay the high bidder payment. In these embodiments, the method typically includes retaining the product and/or service from the non-paying high bidder. In certain embodiments, at least one of the low bidder payments comprises an amount equal to or greater than the target price less the deposit received from a given low bidder in the low bidder population. In some embodiments, the method includes returning the deposit received from at least one non-paying low bidder in the bidder population when the non-paying low bidder fails to pay the low bidder payment, in these embodiments, the method typically includes retaining the product and/or service from the non-paying low bidder. In some embodiments, the methods include establishing at least one cost of at least one quantity of the product and/or service with at least one supplier prior to, concurrent with, or after receiving the bids. In certain embodiments, the methods include establishing different costs of different quantities of the product and/or service with at least one supplier prior to, concurrent with, or after receiving the bids.

In another aspect, the invention provides a computer-implemented method of providing a product and/or service to a buyer population. The method includes providing electronic digital information to the at least one prospective bidder that causes at least one attribute of the product and/or service to be displayed, and/or receiving at least one request for the product and/or service from at least one prospective bidder. The method also includes receiving bids for the product and/or service from a number of bidders to generate at least one bidder population, wherein a bid comprises a bid price that at least one bidder will pay to receive at least one unit of the product and/or service. The method also includes selecting at least one buyer population from the bidder population when a number of bids comprising bid prices at or above at least one target price equals or exceeds at least one threshold number, wherein the buyer population comprises bids comprising bid prices at or above the target price. The method also includes making the product and/or service available to the buyer population and receiving payments from at least a portion of the buyer population, wherein a payment comprises an amount equal to or greater than the bid price of the bid received from a given bidder in the buyer population, thereby providing the product and/or service to the buyer population.

In some embodiments, the computer-implemented methods include receiving the request for the product and/or service from the prospective bidder in electronic digital form. In some embodiments, the methods include receiving the bids for the product and/or service after a number of requests for the product and/or service equals or exceeds at least one selected number. In certain embodiments, the methods include receiving the bids for the product and/or service from the number of bidders in electronic digital form. Typically, the number of bids, the target price and/or the threshold number is unknown at least to the bidder population. In some embodiments, the methods include establishing at least one cost of at least one quantity of the product and/or service with at least one supplier prior to, concurrent with, or after receiving the bids. In certain embodiments, the methods include establishing different costs of different quantities of the product and/or service with at least one supplier prior to, concurrent with, or after receiving the bids. In some embodiments, the selecting step comprises querying at least one database that comprises the threshold number. The database typically comprises a plurality of threshold numbers indexed to a plurality of different products and/or services. In some embodiments, the database comprises threshold numbers indexed to selected option profiles for the product and/or service.

In certain embodiments, the computer-implemented methods include obtaining at least one quantity of the product and/or service from at least one supplier at a cost at or below the target price. Typically, the target price is unknown to the supplier. In some embodiments, the quantity of the product and/or service equals or exceeds the threshold number.

In some embodiments, the computer-implemented methods include receiving at least one deposit from one or more of the bidders in the bidder population and/or the buyer population. In some of these embodiments, the methods include receiving the deposit from one or more of the bidders prior to selecting the buyer population when selecting the buyer population, or after selecting the buyer population.

In certain embodiments, the computer-implemented methods include providing feedback to one or more bidders in response to the bids received from the bidders. In some of these embodiments, the feedback comprises a probability of the bidders being included in the buyer population.

In another aspect, the invention provides a machine-readable medium having stored thereon one or more logic instructions which, when executed by a machine, cause the machine to provide information to at least one prospective bidder that causes at least one attribute of at least one product and/or service to be displayed, and/or receive at least one request for at least one product and/or service from at least one prospective bidder; receive bids for the product and/or service from a number of bidders to generate at least one bidder population, wherein a bid comprises a bid price that at least one bidder will pay to receive at least one unit of the product and/or service; select at least one buyer population from the bidder population when a number of bids comprising bid prices at or above at least one target price equals or exceeds at least one threshold number, wherein the buyer population comprises bids comprising bid prices at or above the target price; and make the product and/or service available to the buyer population and receive payments from at least a portion of the buyer population, wherein a payment comprises an amount equal to or greater than the bid price of the bid received from a given bidder in the buyer population.

In another aspect, the invention provides a system that includes at least one processor, and at least one memory component in communication with the processor. The memory component comprises one or more instructions that, when executed, cause the processor to: provide information that causes at least one attribute of at least one product and/or service to be displayed, and/or receive at least one request for at least one product and/or service from at least one prospective bidder; receive bids for the product and/or service from a number of bidders to generate at least one bidder population, wherein a bid comprises a bid price that at least one bidder will pay to receive at least one unit of the product and/or service, and wherein the bid price of at least a first bidder is unknown to at least a second bidder; receive one or more deposits from one or more of the bidders in the bidder population; segment the bidder population into at least one buyer population and at least one remainder population when a number of bids comprising bid prices at or above at least one target price equals or exceeds at least one threshold number, wherein the buyer population comprises bids comprising bid prices at or above the target price, wherein the remainder population comprises bids comprising bid prices below the target price, and wherein the number of bids, the target price and/or the threshold number is unknown to the bidder population; make the product and/or service available to the buyer population and to the remainder population e.g., send notice to the buyer and remainder populations, etc.); receive buyer payments from paying buyers in the buyer population, wherein a buyer payment comprises an amount equal to or greater than the bid price of the bid received from a given bidder in the buyer population less the deposit received from the given bidder in the buyer population; retain the deposit received from at least one non-paying buyer in the buyer population when the non-paying buyer fails to pay the buyer payment; retain the product and/or service from the non-paying buyer when the non-paying buyer fails to pay the buyer payment; receive remainder payments, if any, from paying remainders in the remainder population, wherein a remainder payment comprises an amount equal to or greater than the target price less the deposit received from a given bidder in the remainder population; return the deposit received from at least one non-paying remainder in the remainder population when the non-paying remainder fails to pay the remainder payment; and retain the product and/or service from the non-paying remainder when the non-paying remainder fails to pay the remainder payment. In some embodiments, a social network (e.g., facebook.com, twitter.com, linkedin.com, pinterest.com, alibaba.com, etc.) or electronic commerce network (e.g., amazon.com, eBay.com, costco.com, groupon.com, etc.) comprises and/or is in communication with the system. In certain embodiments, the memory component comprises at least one instruction that, when executed, causes the processor to effect receiving the bids for the product and/or service after a number of requests for the product and/or service equals or exceeds at least one selected number.

In some embodiments, the memory component comprises at least one instruction that, when executed, causes the processor to effect obtaining at least one quantity of the product and/or service from at least one supplier at a cost at or below the target price. Typically, the quantity of the product and/or service equals or exceeds the threshold number. In some embodiments, the system also includes at least one server providing a web page accessible to bidders.

In certain embodiments, the system includes at least one database that comprises the threshold number, wherein the memory component comprises at least one instruction that, when executed, causes the processor to query the database to determine whether the number of bids comprising bid prices at or above the target price equals or exceeds the threshold number. In some embodiments, the database comprises a plurality of threshold numbers indexed to a plurality of different products and/or services. In certain embodiments, the database comprises threshold numbers indexed to buyer selected option profiles for the product and/or service.

In another aspect, the invention provides a system that includes at least one storage device storing instructions, and at least one processor in communication with the storage device. The processor is operative with the instructions to: provide electronic digital information to at least one prospective bidder that causes at least one attribute of the product and/or service to be displayed, and/or receive at least one request for the product and/or service from at least one prospective bidder; receive bids for the product and/or service from a number of bidders to generate at least one bidder population, wherein a bid comprises a bid price that at least one bidder will pay to receive at least one unit of the product and/or service; select at least one buyer population from the bidder population when a number of bids comprising bid prices at or above at least one target price equals or exceeds at least one threshold number, wherein the buyer population comprises bids comprising bid prices at or above the target price; make the product and/or service available to the buyer population; and, receive payments from at least a portion of the buyer population, wherein a payment comprises an amount equal to or greater than the bid price of the bid received from a given bidder in the buyer population, thereby providing the product and/or service to the buyer population. In certain embodiments, a social network (e.g., facebook.com, twitter.com, linkedin.com, pinterest.com, alibaba.com, etc.) or electronic commerce network (e.g., amazon.com, eBay.com, costco.com, groupon.com, etc.) comprises and/or is in communication with the system.

In some embodiments, the processor is operative with the instructions to receive the request for the product and/or service from the prospective bidder in electronic digital form. In some embodiments, the processor is operative with the instructions to receive the bids for the product and/or service after a number of requests for the product and/or service equals or exceeds at least one selected number. In certain embodiments, the processor is operative with the instructions to receive the bids for the product and/or service from the number of bidders in electronic digital form. In some embodiments, the processor is operative with the instructions to receive at least one deposit from one or more of the bidders in the bidder population and/or the buyer population. In some embodiments, the processor is operative with the instructions to provide feedback to one or more bidders in response to the bids received from the bidders. In certain of these embodiments, the feedback comprises a probability of the bidders being included in the buyer population. In certain embodiments, the processor is operative with the instructions to effect obtaining at least one quantity of the product and/or service from at least one supplier at a cost at or below the target price. In these embodiments, the target price is unknown to the supplier. Typically, the system includes at least one server providing a web page accessible to bidders. The number of bids, the target price and/or the threshold number is generally unknown at least to the bidder population.

In certain embodiments, the system includes at least one database that comprises the threshold number, wherein the processor is operative with the instructions to query the database to determine whether the number of bids comprising bid prices at or above the target price equals or exceeds the threshold number. In some embodiments, the database comprises a plurality of threshold numbers indexed to a plurality of different products and/or services. In some embodiments, the database comprises threshold numbers indexed to selected option profiles for the product and/or service.

In one aspect, the invention provides a method of conducting a transaction to buy a product and/or service. The method includes placing at least one bid for at least one product and/or service into a system that includes at least one computing component that comprises and/or communicates with one or more instructions that, when executed, cause the computing component and/or another system component in communication with the computing component to: provide information that causes at least one attribute of at least one product and/or service to be displayed, and/or receive at least one request for at least one product and/or service from at least one prospective bidder; receive bids for the product and/or service from a number of bidders to generate at least one bidder population, wherein a bid comprises a bid price that at least one bidder will pay to receive at least one unit of the product and/or service, and wherein the bid price of at least a first bidder is unknown to at least a second bidder; receive one or more deposits from one or more of the bidders in the bidder population, wherein a deposit comprises an amount equal to at least a portion of the bid price of the bid received from a given bidder in the bidder population; segment the bidder population into at least one buyer population and at least one remainder population when a number of bids comprising bid prices at or above at least one target price equals or exceeds at least one threshold number, wherein the buyer population comprises bids comprising bid prices at or above the target price, wherein the remainder population comprises bids comprising bid prices below the target price, and wherein the number of bids, the target price and/or the threshold number is unknown to the bidder population; send notice to bidders in the buyer population that the product and/or service is available at the bid prices of the bids received from the bidders in the buyer population when the bidder population is segmented into the buyer population and the remainder population; send notice to bidders in the remainder population that the product and/or service is unavailable at the bid prices of the bids received from the bidders in the remainder population when the bidder population is segmented into the buyer population and the remainder population; send at least one offer to buy the product and/or service for at least one offer price to at least a portion of the remainder population; receive buyer payments from paying buyers in the buyer population, wherein a buyer payment comprises an amount equal to or greater than the bid price of the bid received from a given bidder in the buyer population less the deposit received from the given bidder in the buyer population; retain the deposits received from the paying buyers; make the product and/or service available to the paying buyers; retain the deposit received from at least one non-paying buyer in the buyer population when the non-paying buyer fails to pay the buyer payment; retain the product and/or service from the non-paying buyer when the non-paying buyer fails to pay the buyer payment; receive remainder payments from paying remainders in the remainder population, wherein a remainder payment comprises an amount equal to or greater than the offer price less the deposit received from a given bidder in the remainder population; retain the deposits received from the paying remainders; make the product and/or service available to the paying remainders; return the deposit received from at least one non-paying remainder in the remainder population when the non-paying remainder fails to pay the remainder payment; retain the product and/or service from the non-paying remainder when the non-paying remainder fails to pay the remainder payment; return the deposit received from at least one bidder in the remainder population when the offer to buy the product and/or service for the offer price is not sent to the bidder; and retain the product and/or service from the bidder in the remainder population when the offer to buy the product and/or service for the offer price is not sent to the bidder. The method also includes making at least one deposit for the product and/or service; receiving notice that the product and/or service is available or unavailable at the bid price placed into the system. The method also includes paying at least a buyer payment and receiving the product and/or service when the notice indicates that the product and/or service is available at the bid price placed into the system; or, forfeiting the deposit when a buyer payment is not paid and not receiving the product and/or service when the notice indicates that the product and/or service is available at the bid price placed into the system; or, receiving an offer to buy the product and/or service for at least one offer price when the notice indicates that the product and/or service is unavailable at the bid price placed into the system, paying at least a remainder payment, and receiving the product and/or service; or, receiving an offer to buy the product and/or service for at least one offer price when the notice indicates that the product and/or service is unavailable at the bid price placed into the system, and receiving at least the deposit when at least the offer price is not paid and not receiving the product and/or service; or, receiving at least the deposit when the notice indicates that the product and/or service is unavailable at the bid price placed into the system and not receiving the product and/or service, thereby conducting the transaction to buy the product and/or service.

In one aspect, the invention provides a system that includes at least one computing component that comprises and/or communicates with one or more instructions that, when executed, cause the computing component and/or another system component in communication with the computing component to: provide information that causes at least one attribute of at least one product and or service to be displayed, and/or receive at least one request for at least one product and/or service from at least one prospective bidder; receive bids for the product and/or service from a number of bidders to generate at least one bidder population, wherein a bid comprises a bid price that at least one bidder will pay to receive at least one unit of the product and/or service, and wherein the bid price of at least a first bidder is unknown to at least a second bidder; receive one or more deposits from one or more of the bidders in the bidder population, wherein a deposit comprises an amount equal to at least a portion of the bid price of the bid received from a given bidder in the bidder population; segment the bidder population into at least one buyer population and at least one remainder population when a number of bids comprising bid prices at or above at least one target price equals or exceeds at least one threshold number, wherein the buyer population comprises bids comprising bid prices at or above the target price, wherein the remainder population comprises bids comprising bid prices below the target price, and wherein the number of bids, the target price and/or the threshold number is unknown to the bidder population; send notice to bidders in the buyer population that the product and/or service is available at the bid prices of the bids received from the bidders in the buyer population when the bidder population is segmented into the buyer population and the remainder population; send notice to bidders in the remainder population that the product and/or service is unavailable at the bid prices of the bids received from the bidders in the remainder population when the bidder population is segmented into the buyer population and the remainder population; send at least one offer to buy the product and/or service for at least one offer price to at least a portion of the remainder population; receive buyer payments from paying buyers in the buyer population, wherein a buyer payment comprises an amount equal to or greater than the bid price of the bid received from a given bidder in the buyer population less the deposit received from the given bidder in the buyer population; retain the deposits received from the paying buyers; make the product and/or service available to the paying buyers; retain the deposit received from at least one non-paying buyer in the buyer population when the non-paying buyer fails to pay the buyer payment; retain the product and/or service from the non-paying buyer when the non-paying buyer fails to pay the buyer payment; receive remainder payments from paying remainders in the remainder population, wherein a remainder payment comprises an amount equal to or greater than the offer price less the deposit received from a given bidder in the remainder population; retain the deposits received from the paying remainders; make the product and/or service available to the paying remainders; return the deposit received from at least one non-paying remainder in the remainder population when the non-paying remainder fails to pay the remainder payment; retain the product and/or service from the non-paying remainder when the non-paying remainder fails to pay the remainder payment; return the deposit received from at least one bidder in the remainder population when the offer to buy the product and/or service for the offer price is not sent to the bidder; and retain the product and/or service from the bidder in the remainder population when the offer to buy the product and/or service for the offer price is not sent to the bidder. In some embodiments of the invention, systems include computing components that comprise at least one processor and at least one memory component in communication with the processor, which memory component comprises the instructions.

In another aspect, the invention provides a method of conducting a transaction to buy a product and/or service. The method includes placing at least one non-binding bid that comprises a requested bid price for at least one product and/or service into a system. The system includes at least one computing component that comprises and/or communicates with one or more instructions that, when executed, cause the computing component and/or another system component in communication with the computing component to: provide information that causes at least one attribute of at least one product and/or service to be displayed, and/or receive at least one request for at least one product and/or service from at least one prospective bidder; receive non-binding bids for the product and/or service from a number of bidders to generate at least one bidder population, wherein a non-binding bid comprises at least one requested bid price that at least one bidder would pay to receive at least one unit of the product and/or service, and wherein the requested bid price of at least a first bidder is unknown to at least a second bidder; receive one or more deposits from one or more of the bidders in the bidder population, wherein a deposit comprises an amount equal to at least a portion of the requested bid price of the non-binding bid received from a given bidder in the bidder population; segment the bidder population into at least one buyer population and at least one remainder population when a number of non-binding bids comprising requested bid prices at or above at least one target price equals or exceeds at least one threshold number, wherein the buyer population comprises non-binding bids comprising requested bid prices at or above the target price, wherein the remainder population comprises non-binding bids comprising requested bid prices below the target price, and wherein the number of requested bids, the target price and/or the threshold number is unknown to the bidder population; send notice to bidders in the buyer population that the product and/or service is available at the requested bid prices of the non-binding bids received from the bidders in the buyer population when the bidder population is segmented into the buyer population and the remainder population, which notice comprises buyer offers to buy the product and/or service at the requested bid prices of the non-binding bids received from the bidders in the buyer population; send notice to bidders in the remainder population that the product and/or service is unavailable at the requested bid prices of the non-binding bids received from the bidders in the remainder population when the bidder population is segmented into the buyer population and the remainder population; send at least one remainder offer to buy the product and/or service for at least one remainder offer price to at least a portion of the remainder population; receive buyer payments from paying buyers in the buyer population, wherein a buyer payment comprises an amount equal to or greater than the requested bid price of the non-binding bid received from a given bidder in the buyer population less the deposit received from the given bidder in the buyer population; retain at least portions of the deposits received from the paying buyers; make the product and/or service available to the paying buyers; retain at least a portion of the deposit received from at least one non-paying buyer in the buyer population when the non-paying buyer fails to pay the buyer payment; retain the product and/or service from the non-paying buyer when the non-paying buyer fails to pay the buyer payment; receive remainder payments from paying remainders in the remainder population, wherein a remainder payment comprises an amount equal to or greater than the remainder offer price less the deposit received from a given bidder in the remainder population; retain at least portions of the deposits received from the paying remainders; make the product and/or service available to the paying remainders; return the deposit received from at least one non-paying remainder in the remainder population when the non-paying remainder fails to pay the remainder payment; retain the product and/or service from the non-paying remainder when the non-paying remainder fails to pay the remainder payment; return the deposit received from at least one bidder in the remainder population when the remainder offer to buy the product and/or service for the remainder offer price is not sent to the bidder; and retain the product and/or service from the bidder in the remainder population when the remainder offer to buy the product and/or service for the remainder offer price is not sent to the bidder. The method also includes making at least one deposit for the product and/or service; receiving notice that the product and/or service is available or unavailable at the non-binding bid price placed into the system; and, accepting the buyer offer, paying at least a buyer payment, and receiving the product and/or service when the notice indicates that the product and/or service is available at the bid price placed into the system; or, declining the buyer offer, forfeiting at least a portion of the deposit when a buyer payment is not paid, and not receiving the product and/or service when the notice indicates that the product and/or service is available at the bid price placed into the system; or, receiving a remainder offer to buy the product and/or service for at least one remainder offer price when the notice indicates that the product and/or service is unavailable at the non-binding bid price placed into the system, paying at least a remainder payment, and receiving the product and/or service; or, receiving a remainder offer to buy the product and/or service for at least one remainder offer price when the notice indicates that the product and/or service is unavailable at the non-binding bid price placed into the system, and receiving at least the deposit when at least a remainder payment is not paid, and not receiving the product and/or service; or, receiving at least the deposit when the notice indicates that the product and/or service is unavailable at the bid price placed into the system and not receiving the product and/or service, thereby conducting the transaction to buy the product and/or service. In some embodiments, the non-binding bid comprises at least one solicitation of an offer.

In another aspect, the invention provides a method of conducting a transaction to buy a product and/or service. The method includes placing at least one bid for at least one product and/or service into a system. The system includes at least one computing component that comprises and/or communicates with one or more instructions that, when executed, cause the computing component and/or another system component in communication with the computing component to: provide information that causes at least one attribute of at least one product and/or service to be displayed, and/or receive at least one request for at least one product and/or service from at least one prospective bidder; receive bids for the product and/or service from a number of bidders to generate at least one bidder population, wherein a bid comprises a bid price that at least one bidder would pay to receive at least one unit of the product and/or service, and wherein the bid price of at least a first bidder is unknown to at least a second bidder; receive one or more deposits from one or more of the bidders in the bidder population, wherein a deposit comprises an amount equal to at least a portion of the bid price of the bid received from a given bidder in the bidder population; segment the bidder population into at least one buyer population and at least one remainder population when a number of bids comprising bid prices at or above at least one target price equals or exceeds at least one threshold number, wherein the buyer population comprises bids comprising bid prices at or above the target price, wherein the remainder population comprises bids comprising bid prices below the target price, and wherein the number of bids, the target price and/or the threshold number is unknown to the bidder population; send notice to bidders in the buyer population that the product and/or service is available at the bid prices of the bids received from the bidders in the buyer population when the bidder population is segmented into the buyer population and the remainder population; send notice to bidders in the remainder population that the product and/or service is unavailable at the bid prices of the bids received from the bidders in the remainder population when the bidder population is segmented into the buyer population and the remainder population; send at least one offer to buy the product and/or service for at least one offer price to at least a portion of the remainder population; receive buyer payments from paying buyers in the buyer population, wherein a buyer payment comprises an amount equal to or greater than the bid price of the bid received from a given bidder in the buyer population less the deposit received from the given bidder in the buyer population; retain at least portions of the deposits received from the paying buyers; make the product and/or service available to the paying buyers; retain at least a portion of the deposit received from at least one non-paying buyer in the buyer population when the non-paying buyer fails to pay the buyer payment; retain the product and/or service from the non-paying buyer when the non-paying buyer fails to pay the buyer payment; receive remainder payments from paying remainders in the remainder population, wherein a remainder payment comprises an amount equal to or greater than the offer price less the deposit received from a given bidder in the remainder population; retain at least portions of the deposits received from the paying remainders; make the product and/or service available to the paying remainders; return the deposit received from at least one non-paying remainder in the remainder population when the non-paying remainder fails to pay the remainder payment; retain the product and/or service from the non-paying remainder when the non-paying remainder fails to pay the remainder payment; return the deposit received from at least one bidder in the remainder population when the offer to buy the product and/or service for the offer price is not sent to the bidder; and retain the product and/or service from the bidder in the remainder population when the offer to buy the product and/or service for the offer price is not sent to the bidder. The method also includes making at least one deposit for the product and/or service; receiving notice that the product and/or service is available or unavailable at the bid price placed into the system; and, paying at least a buyer payment and receiving the product and/or service when the notice indicates that the product and/or service is available at the bid price placed into the system; or, forfeiting the deposit when a buyer payment is not paid and not receiving the product and/or service when the notice indicates that the product and/or service is available at the bid price placed into the system; or, receiving an offer to buy the product and/or service for at least one offer price when the notice indicates that the product and/or service is unavailable at the bid price placed into the system, paying at least a remainder payment, and receiving the product and/or service; or, receiving an offer to buy the product and/or service for at least one offer price when the notice indicates that the product and/or service is unavailable at the bid price placed into the system, and receiving at least the deposit when at least the offer price is not paid and not receiving the product and/or service; or, receiving at least the deposit when the notice indicates that the product and/or service is unavailable at the bid price placed into the system and not receiving the product and/or service, thereby conducting the transaction to buy the product and/or service.

In some embodiments of the methods, systems, and other aspects of the invention, bids are non-binding. In some embodiments, a bid comprises a solicitation of an offer. In certain embodiments, bidders agree to keep deposits with at least one system operator for specified periods of time. In some embodiments, bidders comprise offerees and/or offerors. In certain embodiments, a system operator comprises an offeree. In some embodiments, a system operator, comprises an offeror. In certain embodiments, target prices and/or threshold numbers are determined prior to placing bids for the product and/or service into systems described herein. In certain embodiments, the bidders comprise offerees, at least one system operator comprises an offeror, and the deposits comprise consideration for option contracts that prevent the system operator from revoking offers to the bidders for specified periods of time. In some embodiments, the deposits comprise liquidated damage amounts agreed to by the bidders and at least one system operator. In some of these embodiments, the liquidated damage amounts are retained by the system operator when non-paying buyers fail to pay buyer payment. In certain embodiments, the deposits comprise transaction fees agreed to by the bidders and at least one system operator, which transaction fees are retained by the system operator when non-paying buyers fail to pay buyer payment. In some embodiments, the notice sent to bidders in the buyer population comprises buyer offers to buy the product and/or service at the bid prices of the bids received from the bidders in the buyer population, wherein at least one system operator comprises an offeror.

### BRIEF DESCRIPTION OF THE DRAWINGS

The description provided herein is better understood when read in conjunction with the accompanying drawings which are included by way of example and not by way of limitation. It will be understood that like reference numerals identify like components throughout the drawings, unless the context indicates otherwise. It will also be understood that some or all of the figures may be schematic representations for purposes of illustration and do not necessarily depict the actual relative sizes or locations of the elements shown.

FIG. 1 is a flow chart that schematically depicts an exemplary method of identifying a buyer population according to one embodiment of the invention.

FIG. 2 is a flow chart that schematically illustrates an exemplary method of providing a product and/or service to a buyer population according to one embodiment of the invention.

FIG. 3 is a flow chart that schematically illustrates an exemplary method of providing a product and/or service to a bidder population according to one embodiment of the invention.

FIG. 4 is a flow chart that schematically shows an exemplary method of providing a product and/or service to a bidder population according to one embodiment of the invention.

FIG. 5 is a flow chart that schematically illustrates an exemplary method of providing a product and/or service to a bidder population according to one embodiment of the invention.

FIG. 6 is a flow chart that schematically illustrates an exemplary method of providing a product and/or service to a bidder population according to one embodiment of the invention.

FIG. 7 is an exemplary screenshot of one illustrative embodiment of the invention.

FIG. 8 is a schematic diagram of an exemplary system suitable for use with certain embodiments of the invention.

### DETAILED DESCRIPTION

The present invention provides systems, machine-readable media (e.g., computer program products, software, and the like), and related methods of providing products and services to buyers, supplying products and services to bidder populations, financing transactions to buy products and services, and managing funds, among many other aspects. To illustrate, the invention provides methods of identifying buyer populations for products and services in certain embodiments. A buyer population typically includes multiple buyers that are each willing to pay at or above a given target price for the products and services. In transactions for the products or services, buyer populations (e.g., via a buyer population representative) are generally able to exert greater bargaining power than individual buyers vis-à-vis the products or services suppliers. As a result, buyers in a given buyer population are typically able to receive, for example, more favorable pricing and/or other terms or conditions in these transactions than buyers acting individually would otherwise receive. Note, it should be understood that “bidder”, “buyer”, and “remainder” when used herein may include, for example, a retail and/or a wholesale “bidder”, “buyer”, and “remainder” as applicable.

### I. Exemplary Methods

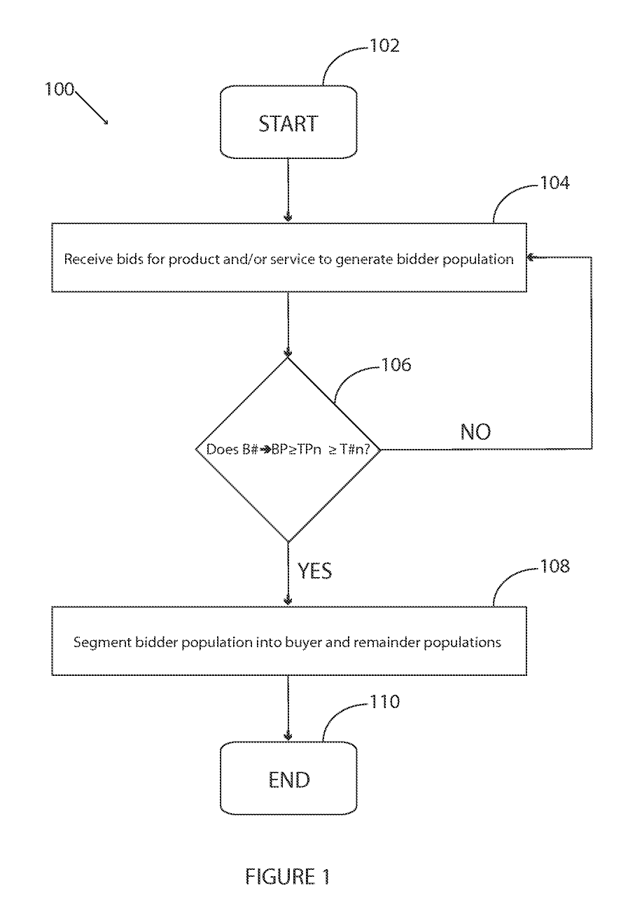

Now referring to FIGS. 1-8, exemplary embodiments of the invention are further illustrated. FIG. 1, for example, provides a flow chart that schematically depicts an exemplary method of identifying a buyer population. As shown, after starting in step 102, method 100 includes receiving bids for a product and/or service from a number of bidders to generate a bidder population in step 104. A bid typically includes a bid price that a given bidder will pay to receive at least one unit of the product and/or service. In certain embodiments, bids are received via a link. A link is any medium for transferring information or data from one point to another point (e.g., from a bidder location to a transaction coordinator or facilitator location). Examples of links include, without limitation, a network such as a LAN, WAN or the Internet, a telecommunications link, a wire or optical link or a wireless connection. In some embodiments, for example, bids are received by a computer system or component thereof via electronic or computer-based communications networks, such as the Internet. Exemplary communications networks and user interfaces are described further herein or are otherwise know to those of skill in the art. In other exemplary embodiments, bids are received telephonically, via a postal service, via a common carrier, or the like. Bids are typically received by a transaction coordinator or facilitator. In some embodiments, the transaction coordinator or facilitator acts as an intermediary between buyers and sellers of the product and/or service.

As shown in steps 106 and 108, method 100 also includes segmenting the bidder population into at least one buyer population and at least one remainder population when a number of bids (B#) including bid prices (BP) at or above at least one target price (TP) equal or exceeds at least one threshold number (T#). The buyer population generally includes bids comprising bid prices at or above the target price, whereas the remainder population typically includes bids comprising bid prices below the target price. In some embodiments, target prices are established based at least in part on market research or other information indicating that at a given level number, n (e.g., a number of bidders submitting bids with bid prices at or above a specified amount) there is a suitable probability that the buyer population will have sufficient bargaining power to obtain the target price for the product and/or service in negotiations, or otherwise communicating, with the supplier or seller of the product and/or service. In certain embodiments, target prices, threshold numbers, and the like are negotiated or otherwise established with the supplier or seller of the product and/or service in advance of or as bids are received for a product and/or service from bidders. Typically, the number of bids, the target price and/or the threshold number is unknown to the bidder population. In the exemplary embodiment shown, method 100 ends with step 110 when the bidder population is segmented into buyer and remainder populations.

Bidder populations and buyer populations can have various sizes. In certain embodiments, for example, bidder populations and/or buyer populations include at least about 10 bidders, at least about 25 bidders, at least about 50 bidders, at least about 100 bidders, at least about 500 bidders, at least about 1000 bidders, at least about 5000 bidders, at least about 10000 bidders, or more bidders. In some embodiments, a size of the buyer population is at least about 5%, at least about 10%, at least about 20%, at least about 30%, at least about 40%, at least about 50%, at least about 60%, at least about 70%, at least about 80%, or at least about 90% of a size of the bidder population. In addition, the threshold number optionally includes at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, at least about 900, at least about 1000, at least about 2000, at least about 3000, at least about 4000, at least about 5000, at least about 6000, at least about 7000, at least about 8000, at least about 9000, at least about 10000, or more in certain embodiments. In some embodiments of the methods of the invention, the bid price of at least a first bidder is unknown to at least a second bidder.

The methods of the invention optionally include receiving at least one request for a given product and/or service from at least one prospective bidder. In some embodiments, at least one of the steps of the methods of the invention is at least partially computer implemented. In certain embodiments, for example, the invention includes a machine-readable medium storing instructions which, when executed by a machine, cause the machine to perform at least a portion of one or more of the methods described herein. Exemplary systems, user interfaces, and computer program products are described further herein.

In certain embodiments of the methods of the invention, the bid comprises at least one selected option profile for the product and/or service. An option profile for a given product or service typically includes particular properties or characteristics sought by a bidder, buyer, and/or remainder. To illustrate, if the product under consideration is an automobile, an option profile might include the automobile's make and model, paint color, interior and exterior styling, audio configuration, engine type, and/or accessories, among many other characteristics.

In some embodiments, the methods of the invention include providing information to prospective bidders that comprises at least one attribute (e.g., an option profile or portion thereof, etc.) of the product and/or service. In some of these embodiments, for example, the methods include providing electronic digital information to the bidders that causes the attribute of the product and/or service to be displayed, for example, by a display device (e.g., a computer monitor, tablet screen, mobile phone screen, etc.) at a given bidder's location.

In certain embodiments, the methods of the invention include querying at least one database that comprises the threshold number. The database typically includes a plurality of threshold numbers indexed to a plurality of different products and/or services. In some embodiments, the database comprises threshold numbers indexed to selected option profiles for the product and/or service.

In certain embodiments, the methods of the invention include providing feedback to one or more bidders in response to the bids received from the bidders. In some of these embodiments, for example, the feedback comprises a probability of the bidders being included in the buyer population.

In certain embodiments of the methods of the invention, the buyer population is selected when B#→BP≧TPₙ≧T#ₙ, where B#→BP≧TP is a number of bidders submitting bid prices at or above at least one target price, BP is a bid price, TP is a target price, n is the level number and is an integer greater than zero, B#→BP≧TPₙ is B#→BP≧TP at a given level number n, T# is a threshold number, and T#ₙ is T# at a given level number n.

In some embodiments, the methods of the invention include obtaining at least one quantity of the product and/or service from at least one supplier at a cost at or below the target price, for example, via a transaction coordinator or facilitator. In certain embodiments, for example, once a buyer population is identified for a particular product and/or service, a transaction coordinator or facilitator contacts one or more suppliers of the product and/or service to negotiate the purchase of the product and/or service for the buyer population at a unit price that is at or below the target price. In some embodiments, the transaction coordinator or facilitator communicates with the suppliers in person, whereas in other embodiments, they communicate with one another via other means, such as via a computer-based system. Typically, the target price is unknown to the supplier. The quantity of the product and/or service obtained (e.g., purchased, etc.) from suppliers generally equals or exceeds the particular threshold number. In certain embodiments, the transaction coordinator or facilitator negotiates or otherwise establishes prices, unit volumes, and/or other terms with suppliers of products and/or services prior to identifying buyer populations.

The methods of the invention also typically include making the product and/or service available to a buyer population (e.g., after a transaction coordinator or facilitator directly or indirectly obtains a quantity of the product and/or service from one or more suppliers; before, after, or concurrent with receiving at least partial payment; and/or the like). In certain embodiments, for example, the product and/or service is made available to the buyer population via essentially any delivery channel. A delivery channel may be implemented by any mechanism or medium that provides for the transfer of the product and/or service to the buyer population from a supplier (e.g. via a transaction coordinator or facilitator). For example, products and services may be made available at one or more distribution centers (e.g., centralized or distributed), by shipping (e.g., mail delivery, courier delivery, delivery agent, etc.) the product and/or service to buyers, via electronic delivery channels, and/or the like.

In some of these embodiments, the methods include receiving buyer payments from paying buyers in the buyer population (e.g., before, after, or concurrent with making the product and/or service available to the buyer population). A buyer payment typically includes an amount equal to or greater than the bid price of the bid received from a given bidder in the buyer population. In certain of these embodiments, the methods include receiving one or more deposits from one or more of the bidders in the bidder population. In some of these embodiments, for example, the methods include receiving the deposit from one or more of the bidders prior to segmenting the bidder population, when segmenting the bidder population, or after segmenting the bidder population. In some of these embodiments, the methods include receiving buyer payments from paying buyers in the buyer population in which at least one buyer payment comprises an amount equal to or greater than the bid price of the bid received from the given bidder in the buyer population less the deposit received from the given bidder in the buyer population. In some embodiments, for example, buyer payments and/or deposits are received by a transaction coordinator or facilitator. In certain embodiments, the methods of the invention include retaining at least a portion of the deposit (e.g., as a liquidated damages amount, a transaction fee, etc.) received from at least one non-paying buyer in the buyer population when the non-paying buyer fails to pay the buyer payment. Typically, these methods also include retaining the product and/or service from the non-paying buyer (e.g., not providing the product and/or service to the non-paying buyer).

In some embodiments, the methods of the invention include making the product and/or service available to a remainder population (e.g., after a transaction coordinator or facilitator directly or indirectly obtains a quantity of the product and/or service from one or more suppliers; before, after, or concurrent with receiving at least partial payment; and/or the like). In certain embodiments, for example, the product and/or service is made available to the remainder population via essentially any delivery channel. A delivery channel may be implemented by any mechanism or medium that provides for the transfer of the product and/or service to the remainder population from a supplier (e.g., via a transaction coordinator or facilitator). For example, products and services may be made available at one or more distribution centers (e.g., centralized or distributed), by shipping (e.g., mail delivery, courier delivery, delivery agent, etc.) the product and/or service to remainders, via electronic delivery channels, and/or the like.

In some of these embodiments, for example, the methods include receiving remainder payments, if any, from paying remainders in the remainder population e.g., before, after, or concurrent with making the product and/or service available to the remainder population). A remainder payment typically comprises an amount equal to or greater than the target price. In certain of these embodiments, the methods include receiving one or more deposits from one or more of the bidders in the remainder population. In some of these embodiments, the methods include receiving the deposit from one or more of the bidders prior to segmenting the bidder population, when segmenting the bidder population, or after segmenting the bidder population. In certain embodiments, the methods of the invention include receiving remainder payments, if any, from paying remainders in the remainder population in which at least one remainder payment comprises an amount equal to or greater than the target price less the deposit received from a given bidder in the remainder population. In certain embodiments, for example, remainder payments and/or deposits are received by a transaction coordinator or facilitator. In some embodiments, these methods include returning the deposit received from at least one non-paying remainder in the remainder population when the non-paying remainder fails to pay the remainder payment. These methods also typically include retaining the product and/or service from the non-paying remainder (e.g., not providing the product and/or service to the non-paying remainder).

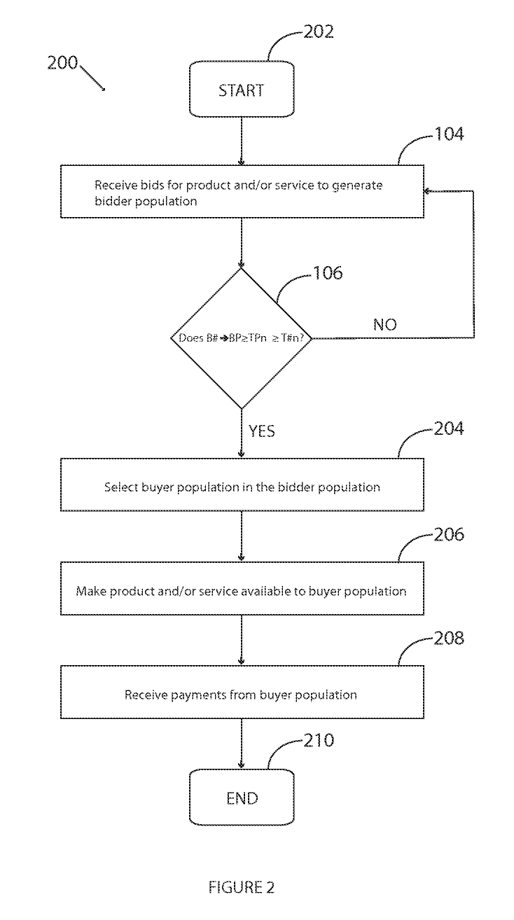

To further illustrate, FIG. 2 provides a flow chart that schematically shows an exemplary method of providing a product and/or service to a buyer population. As shown, after starting in step 202, method 200 includes receiving bids for the product and/or service from a number of bidders to generate at least one bidder population in step 104. Method 200 also includes selecting at least one buyer population in the bidder population when a number of bids comprising bid prices at or above at least one target price equals or exceeds at least one threshold number in which the buyer population comprises bids comprising bid prices at or above the target price (steps 106 and 204). In addition, method 200 also includes making the product and/or service available to the buyer population (step 206), and receiving payments from at least a portion of the buyer population (step 208). A payment typically comprises an amount equal to or greater than the bid price of the bid received from a given bidder in the buyer population. Method 200 generally ends with step 210. Typically, the bid comprises the bid price that the bidder will pay to receive at least one unit of the product and/or service. In some embodiments, the buyer population comprises only bids comprising bid prices at or above the target price. In certain embodiments, the number of bids, the target price and/or the threshold number is unknown at least to the buyer population. In certain embodiments, the method includes receiving at least one deposit from one or more of the bidders in the bidder population and/or the buyer population. In some of these embodiments, for example, the method includes receiving the deposit from one or more of the bidders prior to selecting the buyer population, when selecting the buyer population, or after selecting the buyer population.

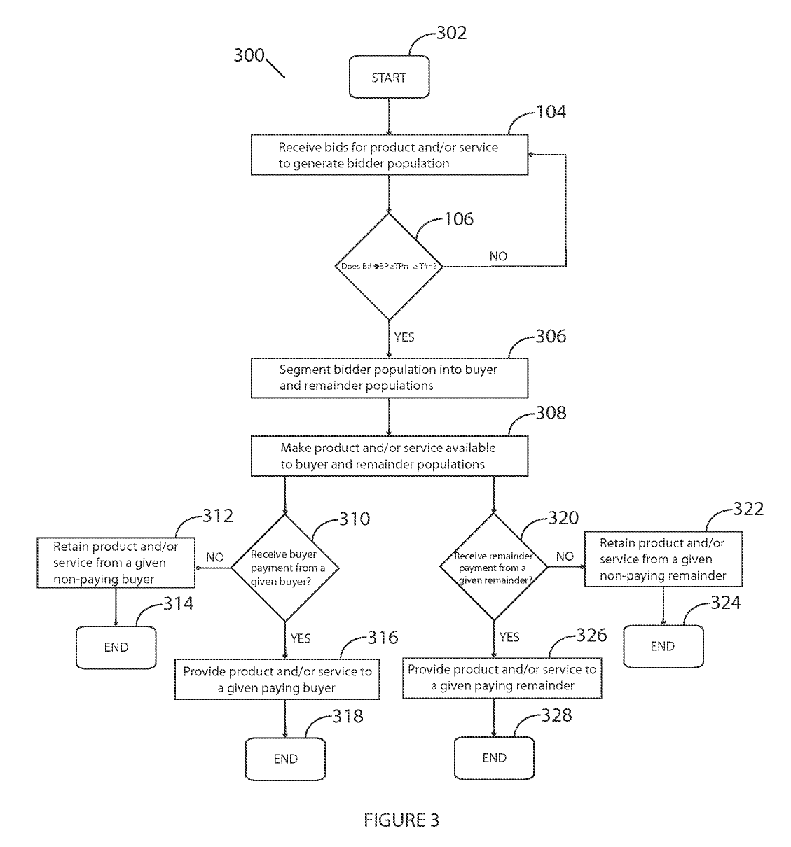

FIG. 3 provides a flow chart that schematically shows a method of providing a product and/or service to a bidder population according to an exemplary embodiment. As shown, after starting in step 302, method 300 includes receiving bids for the product and/or service from a number of bidders to generate at least one bidder population (step 104) in which a bid comprises a bid price that at least one bidder will pay to receive at least one unit of the product and/or service. Method 300 also includes segmenting the bidder population into at least one buyer population and at least one remainder population when a number of bids comprising bid prices at or above at least one target price equals or exceeds at least one threshold number (steps 106 and 306). The buyer population typically includes bids comprising bid prices at or above the target price, whereas the remainder population generally includes bids comprising bid prices below the target price. The number of bids, the target price and/or the threshold number is generally unknown to the bidder population.

Method 300 also includes making the product and/or service available to the buyer population and to the remainder population (step 308). Method 300 also includes receiving buyer payments from paying buyers in the buyer population steps 310 and 316) in which a buyer payment comprises an amount equal to or greater than the bid price of the bid received from a given bidder in the buyer population. In addition, method 300 also includes receiving remainder payments, if any, from paying remainders in the remainder population (steps 320 and 326) in which a remainder payment comprises an amount equal to or greater than the target price. As also shown in step 312, when a payment is not received from a given buyer (e.g., a non-paying buyer), the product and/or service is retained (e.g., by the transaction coordinator or facilitator). Similarly, when a payment is not received from a given remainder (e.g., a non-paying remainder), the product and/or service is retained (e.g., by the transaction coordinator or facilitator) (step 322). Method 300 ends for a given buyer or remainder with step 314, 318, 328, or 324, as applicable.

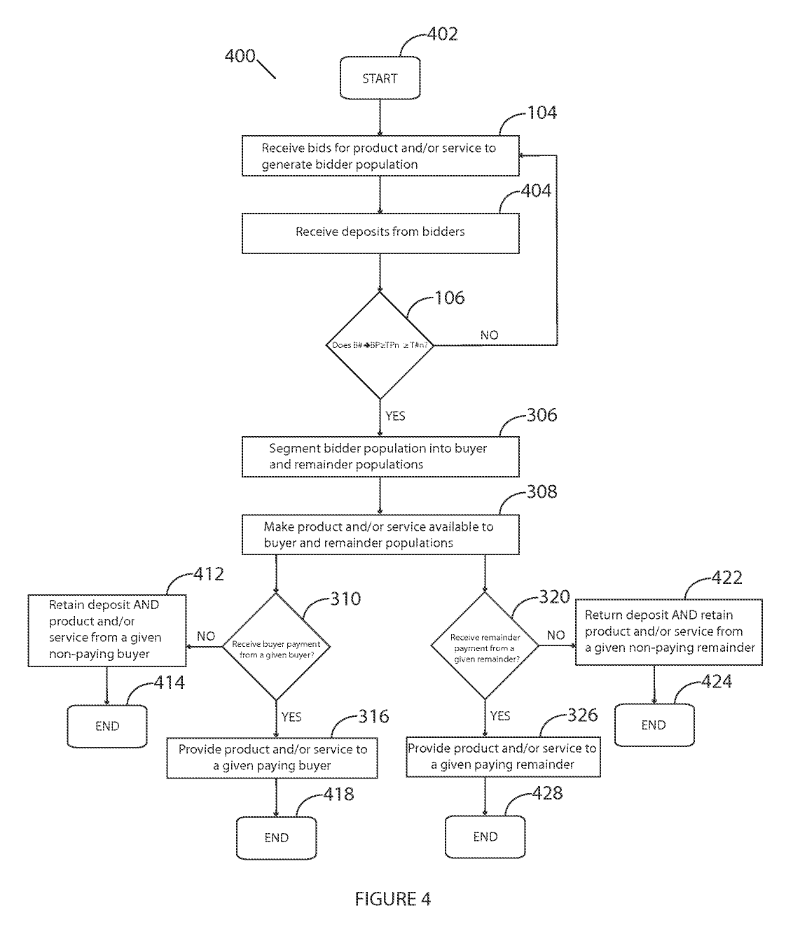

FIG. 4 provides a flow chart that schematically shows a method of providing a product and/or service to a bidder population according to another exemplary embodiment. As shown, after starting in step 402, method 400 includes receiving bids for the product and/or service from a number of bidders to generate at least one bidder population step 104) in which a bid comprises a bid price that at least one bidder will pay to receive at least one unit of the product and/or service. Method 400 also includes receiving one or more deposits from one or more of the bidders in the bidder population (step 404). Method 400 further includes segmenting the bidder population into at least one buyer population and at least one remainder population when a number of bids comprising bid prices at or above at least one target price equals or exceeds at least one threshold number (steps 106 and 306). The buyer population typically includes bids comprising bid prices at or above the target price, while the remainder population generally includes bids comprising bid prices below the target price. Typically, the number of bids, the target price and/or the threshold number is unknown to the bidder population.

Method 400 also includes making the product and/or service available to the buyer population and to the remainder population (step 308), and receiving buyer payments from paying buyers in the buyer population (steps 310 and 316). A buyer payment generally comprises an amount equal to or greater than the bid price of the bid received from a given bidder in the buyer population less the deposit received from the given bidder in the buyer population. Method 400 also includes providing the product and/or service to a given paying buyer in step 316. Method 400 also includes retaining at least a portion of the deposit (e.g., as a liquidated damages amount, a transaction fee, etc.) received from at least one non-paying buyer in the buyer population when the non-paying buyer fails to pay the buyer payment, and retaining the product and/or service from the non-paying buyer (step 412).

Method 400 also includes receiving remainder payments, if any, from paying remainders in the remainder population (steps 320 and 326). A remainder payment typically comprises an amount equal to or greater than the target price less the deposit received from a given bidder in the remainder population. Method 400 also includes providing the product and/or service to a given paying remainder in step 326. Method 400 also includes returning the deposit received from at least one non-paying remainder in the remainder population when the non-paying remainder fails to pay the remainder payment (step 422). In addition, method 400 also includes retaining the product and/or service from the non-paying remainder step 422). Method 400 ends for a given buyer or remainder with step 414, 418, 428, or 424, as applicable.

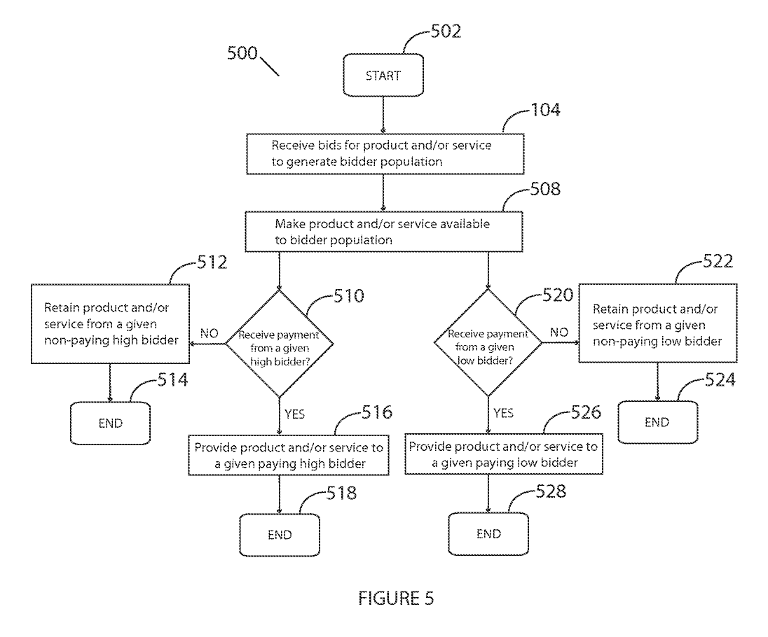

To further illustrate, FIG. 5 provides a flow chart that schematically shows a method of providing a product and/or service to a bidder population. As shown, method 500 includes receiving bids for the product and/or service from a number of bidders to generate at least one bidder population (step 104). A given bid generally includes a bid price that at least one bidder will pay to receive at least one unit of the product and/or service. Method 500 also includes making the product and/or service available to the bidder population (step 508), for example, when a number of bids comprising bid prices at or above at least one target price equals or exceeds at least one threshold number. Typically, the bid price of a given bidder, the number of bids, the target price, and/or the threshold number is unknown to the bidder population.

Method 500 also includes receiving high bidder payments from high bidders in the bidder population (steps 510 and 516). A given high bidder payment generally comprises an amount equal to or greater than the bid price of the bid received from a given high bidder in the bidder population and the bid price of the bid received from the given high bidder typically equals or exceeds the target price. Method 500 also includes retaining the product and/or service from a given non-paying high bidder (e.g., when the high bidder fails to make a payment for the product and/or service) (step 512). In addition, method 500 also includes receiving low bidder payments, if any, from paying low bidders in the bidder population (steps 520 and 526). A low bidder payment typically comprises an amount equal to or greater than the target price. Method 500 also includes retaining the product and/or service from a given non-paying low bidder (e.g., when the low bidder fails to make a payment for the product and/or service) (step 522). Method 500 ends for a given bidder with step 514, 518, 528, or 524, as applicable.

Typically, method 500 also includes obtaining (e.g., via a transaction coordinator or facilitator) at least one quantity of the product and/or service from at least one supplier at a cost at or below at least one target price when a number of bids comprising bid prices at or above the target price equals or exceeds at least one threshold number. In some embodiments, method 500 includes receiving one or more deposits from one or more of the bidders in the bidder population. In certain embodiments, method 500 includes receiving the deposit from one or more of the bidders prior to making the product and/or service available to the bidder population. In some of these embodiments, at least one of the high bidder payments comprises an amount equal to or greater than the bid price of the bid received from the given high bidder in the bidder population less the deposit received from the given high bidder in the bidder population. In some of these embodiments, method 500 includes retaining the at least a portion of the deposit (e.g., as a liquidated damages amount, a transaction fee, etc.) received from at least one non-paying high bidder in the bidder population when the non paying high bidder fails to pay the high bidder payment. In these embodiments, method 500 typically includes retaining the product and/or service from the non-paying high bidder. In certain embodiments, at least one of the low bidder payments comprises an amount equal to or greater than the target price less the deposit received from a given low bidder in the low bidder population. In some embodiments, method 500 includes returning the deposit received from at least one non-paying low bidder in the bidder population when the non-paying low bidder fails to pay the low bidder payment. In these embodiments, method 500 typically includes retaining the product and/or service from the non-paying low bidder.

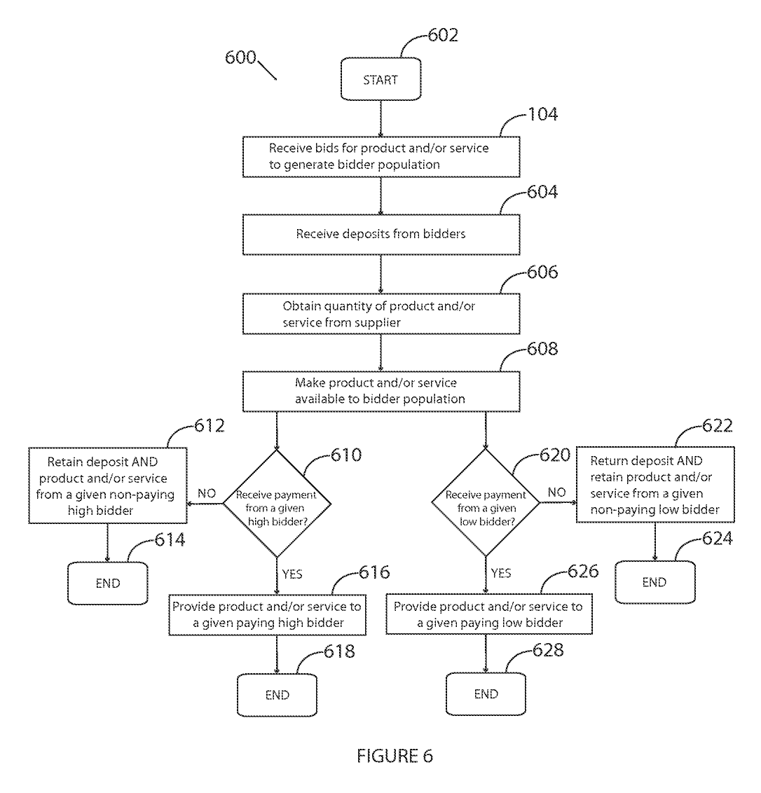

FIG. 6 provides a flow chart that schematically shows a method of providing a product and/or service to a bidder population according to another exemplary embodiment. As shown, method 600 includes receiving bids for the product and/or service from a number of bidders to generate at least one bidder population (step 104). A given bid typically comprises a bid price that at least one bidder will pay to receive at least one unit of the product and/or service. Method 600 also includes receiving one or more deposits from one or more of the bidders in the bidder population (step 604). Method 600 also includes obtaining (e.g., via a transaction coordinator or facilitator) at least one quantity of the product and/or service from at least one supplier at a cost at or below at least one target price when a number of bids comprising bid prices at or above the target price equals or exceeds at least one threshold number step 606). Typically, the bid price of a given bidder, the number of bids, the target price, and/or the threshold number is unknown to the bidder population and/or to the supplier. Method 600 also includes making the product and/or service available to the bidder population (step 608). Method 600 also includes receiving high bidder payments from high bidders in the bidder population (steps 610 and 616). A high bidder payment typically comprises an amount equal to or greater than the bid price of the bid received from a given high bidder in the bidder population less the deposit received from the given high bidder in the bidder population and the bid price of the bid received from the given high bidder generally equals or exceeds the target price. Method 600 also includes providing the product and/or service to a given paying high bidder (step 616). Method 600 also includes retaining at least a portion of the deposit (e.g., as a liquidated damages amount, a transaction fee, etc.) received from at least one non-paying high bidder in the bidder population when the non-paying high bidder fails to pay the high bidder payment, and retaining the product and/or service from the non-paying high bidder (step 612).

Method 600 also includes receiving low bidder payments, if any, from paying low bidders in the bidder population (steps 620 and 626). A given low bidder payment typically comprises an amount equal to or greater than the target price less the deposit received from a given low bidder in the low bidder population. Method 600 also includes providing the product and/or service to a given paying low bidder step 626). Method 600 also includes returning the deposit received from at least one non-paying low bidder in the bidder population when the non-paying low bidder fails to pay the low bidder payment step 622). In addition, method 600 also includes retaining the product and/or service from the non-paying low bidder (step 622). Method 600 ends for a given bidder with step 614, 618, 628, or 624, as applicable.

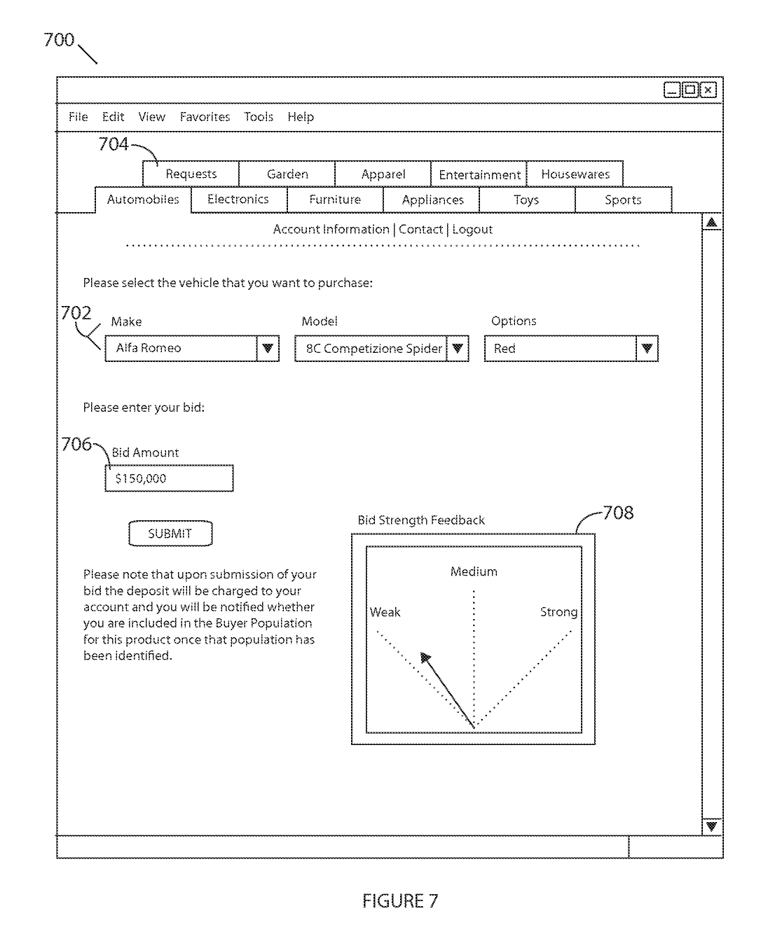

FIG. 7 is an exemplar screenshot of one illustrative user-interface (e.g., a graphical user interface (GUI)) that is optionally used to perform a computer-implemented method of providing a product and/or service to a buyer population. Any of the methods described herein is optionally at least partially computer-implemented in certain embodiments of the invention. As shown, screenshot 700 schematically shows a user-interface for allowing a bidder's information to be entered on server 802. In some embodiments, for example, the method includes providing electronic digital information (e.g., via an electronic digital form or the like) to the bidders or buyers that causes at least one attribute of the product and/or service to be displayed. To illustrate, in screenshot 700 under the “Automobiles” tab, attributes 702 (e.g., “Make”, “Model”, and “Options”) are shown. In addition, requests for a product and/or service are also optionally received (e.g., via an electronic digital form or the like) from prospective bidders using “Requests” tab 704 in the exemplary embodiment shown in FIG. 7. The method also includes receiving bids for the selected product and/or service from a number of bidders to generate at least one bidder population in which a given bid comprises a bid price that at least one bidder will pay to receive at least one unit of the product and/or service. Bid amounts are submitted via box 706 of the user-interface shown in screenshot 700. The method also includes selecting at least one buyer population in the bidder population when a number of bids comprising bid prices at or above at least one target price equals or exceeds at least one threshold number. The buyer population includes bids comprising bid prices at or above the target price. The method also includes making the product and/or service available to the buyer population and receiving payments from at least a portion of the buyer population in which a payment comprises an amount equal to or greater than the bid price of the bid received from a given bidder in the buyer population.

Typically, the number of bids, the target price and/or the threshold number is unknown at least to the bidder population. In some embodiments, the selecting step comprises querying at least one database that comprises the threshold number. The database typically comprises a plurality of threshold numbers indexed to a plurality of different products and/or services. In some embodiments, the database comprises threshold numbers indexed to selected option profiles for the product and/or service. Databases optionally used in the methods and systems of the invention are described further herein.

In certain embodiments, the computer-implemented methods include obtaining (e.g., via a transaction coordinator or facilitator) at least one quantity of the product and/or service from at least one supplier at a cost at or below the target price. Typically, the target price is unknown to the supplier. In some embodiments, the quantity of the product and/or service equals or exceeds the threshold number.

In some embodiments, the computer-implemented methods include receiving at least one deposit from one or more of the bidders in the bidder population and/or the buyer population. In some of these embodiments, the methods include receiving the deposit from one or more of the bidders prior to selecting the buyer population, when selecting the buyer population, or after selecting the buyer population.

In certain embodiments, the computer-implemented methods include providing feedback to one or more bidders in response to the bids received from the bidders. In some of these embodiments, the feedback comprises a probability of the bidders being included in the buyer population. To illustrate, screenshot 700 includes “Bid Strength Feedback” box 708, which provides feedback to bidders when bidders enter bids into box 706.

### II. Exemplary Computer Program Products and Systems

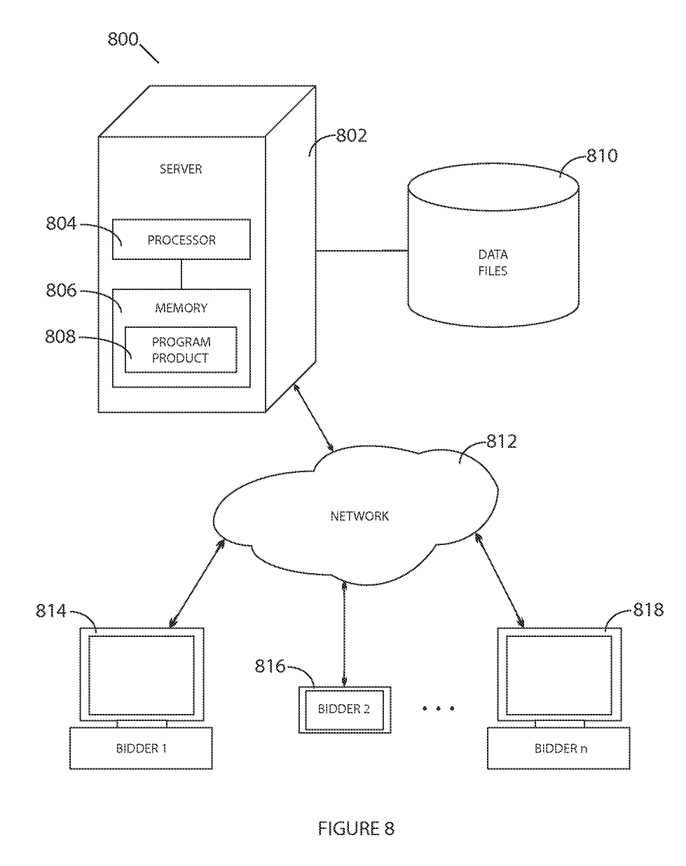

The present invention also provides various systems and computer program products or machine readable media. In some embodiments, for example, the methods of the invention are optionally performed or facilitated at least in part using systems, cloud computing services, computer program products, machine readable media, and/or the like. To illustrate, FIG. 8 provides a schematic diagram of an exemplary system suitable for use with certain embodiments of the invention. As shown, system 800 includes at least one e-commerce computer, e.g., server 802, which includes processor 804 and memory, storage device, or memory component 806, and one or more other communication devices 814, 816, and 818 (e.g., computers, telephones, tablets, PDAs, other mobile devices, etc.) positioned remote from and in communication with the search engine remote server 802, through electronic communication network 812, such as the Internet or other internetwork. System 800 also includes program product 808 stored on a computer or machine readable medium, such as, for example, one or more of various types of memory, such as memory 806 of server 802, that is readable by the server 802, to facilitate a guided navigational search by one or more other communication devices 814, 816, and 818. In some embodiments, system 800 optionally also includes at least one database server, such as, for example, server 810 associated with the online website having data stored thereon searchable either directly or through search engine server 802. System 800 optionally also includes one or more other search engine servers positioned remotely from server 802, each of which are optionally associated with one or more database servers 810 located remotely or located local to each of the other servers. The other servers can beneficially provide service to geographically remote users, and enhance geographically distributed operations.

As understood by those skilled in the art, memory 806 of the server 802 optionally includes volatile and/or nonvolatile memory known to those skilled in the art including, for example, RAM, ROM, and magnetic or optical disks, among others. It should also be understood by those skilled in the art that although illustrated as a single server, the illustrated configuration of server 802 is given by way of example and that other types of servers or computers configured according to various other methodologies known to those skilled in the art can be used. Server 802 shown schematically in FIG. 8, represents a server or server duster or server farm and is not limited to any individual physical server. The server site may be deployed as a server farm or server cluster managed by a server hosting provider. The number of servers and their architecture and configuration may be increased based on usage, demand and capacity requirements for the system 800. As also understood by those skilled in the art, other user communication devices 814, 816, and 818 in these embodiments, for example, can be a laptop, desktop, tablets, personal digital assistants or PDAs, cell phones, servers, computers, or other types of computers. As known and understood by those skilled in the art, the network 812 can include an internet or world wide web of a plurality of computers/servers in communication with one or more other computers through a communication network, and/or portions of a local or other area network.

As further understood by those skilled in the art, exemplary program product or machine readable medium 808 is optionally in the form of microcode, programs, cloud computing format, routines, and/or symbolic languages that provide one or more sets of ordered operations that control the functioning of the hardware and direct its operation, as known and understood by those skilled in the art. Program product 808, according to an exemplary embodiment of the present invention, also need not reside in its entirety in volatile memory, but can be selectively loaded, as necessary, according to various methodologies as known and understood by those skilled in the art.

As further understood by those ski led in the art, the term “computer-readable medium” or “machine-readable medium” refers to any medium that participates in providing instructions to a processor for execution. To illustrate, the term “computer-readable medium” or “machine-readable medium” encompasses distribution media, cloud computing formats, intermediate storage media, execution memory of a computer, and any other medium or device capable of storing the program product 808 implementing the functionality or processes of various embodiments of the present invention, for example, for reading by a computer. A “computer-readable medium” or “machine-readable medium” may take many forms, including but not limited to, non-volatile media, volatile media, and transmission media. Non-volatile media includes, for example, optical or magnetic disks. Volatile media includes dynamic memory, such as the main memory of a given system. Transmission media includes coaxial cables, copper wire and fiber optics, including the wires that comprise a bus. Transmission media can also take the form of acoustic or light waves, such as those generated during radio wave and infrared data communications, among others. Exemplary forms of computer-readable media include a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Program product 808 is optionally copied from the computer-readable medium to a hard disk or a similar intermediate storage medium. When program product 808, or portions thereof, are to be run, it is optionally loaded from their distribution medium, their intermediate storage medium, or the like into the execution memory of one or more computers, configuring the computer(s) to act in accordance with the functionality or method of various embodiments this invention. All such operations are well known to those skilled in the art of, for example, computer systems.

To further illustrate, in certain embodiments, the invention provides systems that include one or more processors, and one or more memory components in communication with the processor. The memory component typically includes one or more instructions that, when executed, cause the processor to provide information that causes at least one attribute of at least one product and/or service to be displayed (e.g., via communication devices 814, 816, 818, or the like) and/or receive at least one request for at least one product and/or service from at least one prospective bidder (e.g., via communication devices 814, 816, 818, or the like) and receive bids (e.g., via communication devices 814, 816, 818, or the like) for the product and/or service from a number of bidders to generate at least one bidder population. In some embodiments, the instructions or processors are configured to receive one or more deposits (e.g., in an electronic form) from one or more of the bidders in the bidder population. The instructions or processors are also typically configured to segment bidder populations into buyer populations and remainder populations when a number of bids comprising bid prices at or above at least one target price equals or exceeds at least one threshold number. In some embodiments, the instructions or processors are configured to make the product and/or service available to the buyer population and to the remainder population (e.g., send notice to the buyer and remainder populations, etc.). In certain embodiments, the instructions or processors are configured to receive buyer payments (e.g., in an electronic form) from paying buyers in the buyer population. In some embodiments, the instructions or processors are configured to retain at least a portion of the deposit received from at least one non-paying buyer in the buyer population when the non-paying buyer fails to pay the buyer payment (e.g., as a liquidated damages amount, a transaction fee, etc.) and/or retain the product and/or service from the non-paying buyer when the non-paying buyer fails to pay the buyer payment. In some embodiments, the instructions or processors are configured to receive remainder payments (e.g., in an electronic form), if any, from paying remainders in the remainder population and/or return the deposit received from at least one non-paying remainder in the remainder population when the non-paying remainder fails to pay the remainder payment. In certain embodiments, the instructions or processors are configured to retain the product and/or service from the non-paying remainder when the non-paying remainder fails to pay the remainder payment.

In some embodiments, memory components include instructions that, when executed, cause, e.g., a processor to effect obtaining at least one quantity of the product and/or service from at least one supplier at a cost at or below the target price (e.g., contact at least one supplier processor or system). Typically, the systems of the invention include at least one server providing web pages accessible to bidders (e.g., FIG. 7).

In some embodiments, systems include at least one database that include threshold numbers. In these embodiments, memory components typically include at least one instruction that, when executed, causes the processor to query the database to determine whether the number of bids including bid prices at or above the target price equals or exceeds the threshold number. In some embodiments, databases include a plurality of threshold numbers indexed to a plurality of different products and/or services. In certain embodiments, databases include threshold numbers indexed to buyer selected option profiles for the product and/or service.

To further illustrate, the invention provides systems that include storage devices storing instructions, and processors in communication with the storage devices. The processors are typically operative with the instructions to provide electronic digital information to the buyers that causes at least one attribute of the product and/or service to be displayed, and/or receive at least one request for the product and/or service from at least one prospective bidder, receive bids for the product and/or service from a number of bidders to generate at least one bidder population in which a bid comprises a bid price that at least one bidder will pay to receive at least one unit of the product and/or service, select at least one buyer population in the bidder population when a number of bids comprising bid prices at or above at least one target price equals or exceeds at least one threshold number in which the buyer population comprises bids comprising bid prices at or above the target price, and make the product and/or service available to the buyer population and receive payments from at least a portion of the buyer population in which a payment comprises an amount equal to or greater than the bid price of the bid received from a given bidder in the buyer population.

In some embodiments, processors are operative with the instructions to receive requests for products and/or services from the prospective bidder in electronic digital form (e.g., FIG. 7, etc.). In certain embodiments, processors are operative with the instructions to receive bids for products and/or services from bidders in electronic digital form (e.g., FIG. 7, etc.). In some embodiments, processors are operative with the instructions to receive at least one deposit from one or more of the bidders in the bidder population and/or the buyer population. In some embodiments, processors are operative with the instructions to provide feedback to one or more bidders in response to the bids received from the bidders. In certain of these embodiments, feedback includes a probability of the bidders being included in the buyer population (e.g., FIG. 7, etc.). In certain embodiments, processors are operative with the instructions to effect obtaining at least one quantity of the product and/or service from at least one supplier at a cost at or below the target price (e.g., communicate with supplier computer systems or the like). In these embodiments, target prices are typically unknown to suppliers. Typically, systems include servers providing web pages accessible to bidders. The number of bids, the target price and/or the threshold number is generally unknown at least to the bidder population in certain embodiments.

In certain embodiments, systems include databases that comprise the threshold number in which processors are operative with the instructions to query the databases to determine whether the number of bids comprising bid prices at or above the target price equals or exceeds threshold numbers. In some embodiments, databases include a plurality of threshold numbers indexed to a plurality of different products and/or services. In some embodiments, databases include threshold numbers indexed to selected option profiles for the products and/or services.

In some embodiments, the invention provides various computer program products or machine-readable media having stored thereon logic instructions which, when executed by a machine, cause the machine to provide information to the buyers that causes at least one attribute of at least one product and/or service to be displayed, and/or receive at least one request for at least one product and/or service from at least one prospective bidder. In certain embodiments, logic instructions are configured to effect receiving bids for products and/or services from a number of bidders to generate at least one bidder population in which a bid comprises a bid price that at least one bidder will pay to receive at least one unit of the product and/or service. In some embodiments, logic instructions are configured to effect selecting at least one buyer population in the bidder population when a number of bids comprising bid prices at or above at least one target price equals or exceeds at least one threshold number in which the buyer population comprises bids comprising bid prices at or above the target price. In certain embodiments, logic instructions are configured to effect making products and/or services available to buyer populations and receiving payments from at least a portion of the buyer population in which a payment comprises an amount equal to or greater than the bid price of the bid received from a given bidder in the buyer population.

The methods, computer program products, systems, and other aspects of the invention include numerous embodiments that are optionally adapted or modified for various uses, for example, by including essentially any combination of method steps, system components, portions thereof, and the like. In certain embodiments described herein, for example, the invention provides methods of conducting transactions to buy products and/or services that include placing or receiving bids for the products and/or services into one or more of the systems described herein, making or receiving deposits for the products and/or services, and receiving or sending notice that the products and/or services are available or unavailable at the bid prices placed into the systems. In other exemplary embodiments described herein, the invention provides methods of supplying products and/or services to bidder populations that include receiving notice at suppliers of the products and/or services that one or more quantities of the products and/or services will be obtained (e.g., purchased or otherwise acquired) from the suppliers. In some of these embodiments, notice is sent to suppliers directly or indirectly from the systems described herein. In certain embodiments of the methods of supplying products and/or services, the methods also include establishing (e.g., negotiating, agreeing, contracting, etc.) the costs of supplying the quantities of the products and/or services prior to, concurrent with, or after receiving the notice to generate established costs, providing the quantities of the products and/or services directly or indirectly to the bidder populations, and receiving payments (e.g., the established costs) for the quantities of the products and/or services. In other exemplary embodiments described herein, the invention provides methods of financing transactions to buy products and/or services. In some of these embodiments, the methods include receiving payment queries at funding sources from a system described herein, and transmitting payments from the funding sources in response to the payment queries (e.g., when the queries meet the selection criteria of the funding sources). To further illustrate, in other exemplary embodiments described herein, the invention provides methods of managing funds. In some of these embodiments, the methods include placing or receiving funds (and/or other items or indicia of value) into accounts with a system operator that includes or otherwise operates or manages a system described herein. In some embodiments, the methods of managing funds include receiving use fees (e.g., interest payments, etc.) from system operators for the use of the funds in the accounts. In certain of these embodiments, the methods of managing funds also include placing or receiving bids for products and/or services into systems, described herein, of the system operators, and paying or receiving payment of at least portions of the bid prices from the funds in the accounts of the system operators when the products and/or services are available at the hid prices placed into the systems. Numerous exemplary variations of these illustrative methods, computer program products, systems, and other aspects of the invention are described further herein.

Additional details relating to computer systems and networks, databases, and computer program products are also provided in, for example, Peterson, Computer Networks: A Systems Approach, Morgan Kaufmann, 5th Ed. (2011), Elmasri, Fundamentals of Database Systems, Addison Wesley, 6th Ed. (2010), Tucker, Programming Languages, McGraw Hill Science/Engineering/Math, 2nd Ed. (2006), and Rhoton, Cloud Computing Architected: Solution Design Handbook, Recursive Press (2011), which are each incorporated by reference in their entirety.

In this specification, the invention has been described with reference to specific exemplary embodiments thereof. However, various modifications and changes may be made thereto without departing from the broader spirit and scope of the invention. The specification and drawings are, accordingly, to be regarded in an illustrative sense rather than a restrictive sense. All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A method of providing a product and/or service to a bidder population, the method comprising:
receiving bids for the product and/or service from a number of bidders to generate at least one bidder population, wherein a bid comprises a bid price that at least one bidder will pay to receive at least one unit of the product and/or service;
receiving one or more deposits from one or more of the bidders in the bidder population;
segmenting the bidder population into at least one buyer population and at least one remainder population when a number of bids comprising bid prices at or above at least one target price equals or exceeds at least one threshold number, wherein the buyer population comprises bids comprising bid prices at or above the target price, wherein the remainder population comprises bids comprising bid prices below the target price, and wherein the number of bids, the target price and/or the threshold number is unknown to the bidder population;
making the product and/or service available to the buyer population and to the remainder population;
receiving buyer payments from paying buyers in the buyer population, wherein a buyer payment comprises an amount equal to or greater than the bid price of the bid received from a given bidder in the buyer population less the deposit received from the given bidder in the buyer population;
retaining at least a portion of the deposit received from at least one non-paying buyer in the buyer population when the non-paying buyer fails to pay the buyer payment;
retaining the product and/or service from the non-paying buyer;
receiving remainder payments, if any, from paying remainders in the remainder population, wherein a remainder payment comprises an amount equal to or greater than the target price less the deposit received from a given bidder in the remainder population;
returning the deposit received from at least one non-paying remainder in the remainder population when the non-paying remainder fails to pay the remainder payment; and,
retaining the product and/or service from the non-paying remainder, thereby providing the product and/or service to the bidder population.

2. The method of claim 1, wherein the bids are non-binding.

3. The method of claim 1, wherein at least one of the steps is at least partially computer implemented.

4. A method of providing a prod and/or service to a bidder population, the method comprising:
receiving bids for the product and/or service from a number of bidders to generate at least one bidder population, wherein a bid comprises a bid price that at least one bidder will pay to receive at least one unit of the product and/or service;
segmenting the bidder population into at least one buyer population and at least one remainder population when a number of bids comprising bid prices at or above at least one target price equals or exceeds at least one threshold number, wherein the buyer population comprises bids comprising bid prices at or above the target price, wherein the remainder population comprises bids comprising bid prices below the target price, and wherein the number of bids, the target price and/or the threshold number is unknown to the bidder population;
making the product and/or service available to the buyer population and to the remainder population;
receiving buyer payments from paying buyers in the buyer population, wherein a buyer payment comprises an amount equal to or greater than the bid price of the bid received from a given bidder in the buyer population; and,
receiving remainder payments, if any, from paying remainders in the remainder population, wherein a remainder payment comprises an amount equal to or greater than the target price, thereby providing the product and/or service to the bidder population.

5. The method of claim 4, comprising receiving one or more deposits from one or more of the bidders in the bidder population.

6. The method of claim 5, wherein at least one of the buyer payments comprises an amount equal to or greater than the bid price of the bid received from the given bidder in the buyer population less the deposit received from the given bidder in the buyer population.

7. The method of claim 5, comprising retaining at least a portion of the deposit received from at least one non-paying buyer in the buyer population when the non-paying buyer fails to pay the buyer payment.

8. The method of claim 7, comprising retaining the product and/or service from the non-paying buyer.

9. The method of claim 5, wherein at least one of the remainder payments comprises an amount equal to or greater than the target price less the deposit received from a given bidder in the remainder population.

10. The method of claim 5, comprising returning the deposit received from at least one non-paying remainder in the remainder population when the non-paying remainder fails to pay the remainder payment.

11. The method of claim 10, comprising retaining the product and/or service from the non-paying remainder.

12. A system, comprising:
at least one processor;
at least one memory component in communication with the processor, which memory component comprises one or more instructions that, when executed, cause the processor to:
provide information that causes at least one attribute of at least one product and/or service to be displayed, and/or receive at least one request for at least one product and/or service from at least one prospective bidder;
receive bids for the product and/or service from a number of bidders to generate at least one bidder population, wherein a bid comprises a bid price that at least one bidder will pay to receive at least one unit of the product and/or service, and wherein the bid price of at least a first bidder is unknown to at least a second bidder;
receive one or more deposits from one or more of the bidders in the bidder population;
segment the bidder population into at least one buyer population and at least one remainder population when a number of bids comprising bid prices at or above at least one target price equals or exceeds at least one threshold number, wherein the buyer population comprises bids comprising bid prices at or above the target price, wherein the remainder population comprises bids comprising bid prices below the target price, and wherein the number of bids, the target price and/or the threshold number is unknown to the bidder population;
make the product and/or service available to the buyer population and to the remainder population;
receive buyer payments from paying buyers in the buyer population, wherein a buyer payment comprises an amount equal to or greater than the bid price of the bid received from a given bidder in the buyer population less the deposit received from the given bidder in the buyer population;
retain at least a portion of the deposit received from at least one non-paying buyer in the buyer population when the non-paying buyer fails to pay the buyer payment;
retain the product and/or service from the non-paying buyer when the non-paying buyer fails to pay the buyer payment;
receive remainder payments, if any, from paying remainders in the remainder population, wherein a remainder payment comprises an amount equal to or greater than the target price less the deposit received from a given bidder in the remainder population;
return the deposit received from at least one non-paying remainder in the remainder population when the non-paying remainder fails to pay the remainder payment; and,
retain the product and/or service from the non-paying remainder when the non-paying remainder fails to pay the remainder payment.

13. The system of claim 12, wherein the memory component comprises at least one instruction that, when executed, causes the processor to effect receiving the bids for the product and/or service after a number of requests for the product and/or service equals or exceeds at least one selected number.

14. The system of claim 12, wherein the memory component comprises at least one instruction that, when executed, causes the processor to effect obtaining at least one quantity of the product and/or service from at least one supplier at a cost at or below the target price.

15. The system of claim 12, wherein the quantity of the product and/or service equals or exceeds the threshold number.

16. The system of claim 12, comprising at least one server providing a web page accessible to bidders.

17. A social network or electronic commerce network comprising and/or in communication with the system of claim 12.

18. The system of claim 12, comprising at least one database that comprises the threshold number, wherein the memory component comprises at least one instruction that, when executed, causes the processor to query the database to determine whether the number of bids comprising bid prices at or above the target price equals or exceeds the threshold number.

19. The system of claim 18, wherein the database comprises a plurality of threshold numbers indexed to a plurality of different products and/or services.

20. The system of claim 18, wherein the database comprises threshold numbers indexed to buyer selected option profiles for the product and/or service.
